(19) United States
(12) Patent Application Publication
(10) Pub. No.: US 2024/0333052 A1
(43) Pub. Date: Oct. 3, 2024

(54) POWER GENERATION DEVICE AND POWER GENERATION SYSTEM

(71) Applicants: Yoshiaki Miyazato, Tokyo (JP); WINSTAR DEVELOPMENT GROUP, Tokyo (JP); THE BIZSER CO., LTD., Tokyo (JP)

(72) Inventors: Yoshiaki Miyazato, Tokyo (JP); Dae Ki Park, Tokyo (JP); Geonwoo Jeon, Tokyo (JP)

(73) Assignees: Yoshiaki Miyazato, Tokyo (JP); WINSTAR DEVELOPMENT GROUP, Tokyo (JP); THE BIZSER CO., LTD., Tokyo (JP)

(21) Appl. No.: 18/272,995

(22) PCT Filed: Aug. 4, 2022
(86) PCT No.: PCT/JP2022/029933

§ 371 Date: Jul. 18, 2023

(30) Foreign Application Priority Data
Jan. 24, 2022 (JP) 2022-008754

(51) Int. Cl. H02K 1/2713; H02K 7/18; H02K 21/16; H02P 9/10; H02P 101/15

(52) U.S. Cl. CPC H02K 1/2713; H02K 7/183; H02K 21/16; H02P 9/105; H02P 2101/15

(57) ABSTRACT

Provided is, for example, a power generation device 10 that performs efficient power generation even with weak input mechanical energy. A power generation device includes: a permanent magnet m having magnetic poles paired in a direction of a rotation axis r1; and a coil C formed by winding a conducting wire around at least one radial axis r2 directed outward from the rotation axis r1, in which a plurality of the permanent magnets m are arranged at predetermined intervals, radially with respect to the rotation axis r1, and along a circumferential direction.

### TECHNICAL FIELD

The present invention relates to a power generation device and a power generation system.

### BACKGROUND ART

As an example of power generation devices using permanent magnets, Patent Literature 1 discloses a cylindrical permanent magnet generator including: a stator including an outside cylinder fixed to a base, a plurality of air core coils circumferentially provided on the inner surface of the outside cylinder, and an outside yoke; and a rotor including a central shaft axially supported by a bearing of the base to be concentric with outside cylinder and rotatable, an inside cylinder penetrated by the central shaft and fixed, a plurality of magnets magnetized on the outer peripheral surface of the inside cylinder such that a magnetic pole direction is along the diameter direction of the cylinder and so as to face mutually opposite sides with the adjacent magnets, and an inside yoke provided inside the inside cylinder, in which the magnet count is an even number of 4 or more and the coil count is one more or one less than the magnet count.

### CITATION LIST

### Patent Literature

Patent Literature 1: JP 2019-216531 A

### SUMMARY OF INVENTION

### Technical Problem

However, in the related art described above, permanent magnets are disposed such that N and S poles are alternate in the rotation direction so that rotation results in a large change in magnetic flux. Therefore, high torque is required to rotate the rotor and, in the case of weak input mechanical energy, examples of which include weak wind during wind power generation, efficient power generation is impossible due to stopped rotation.

The present invention has been made in view of the above problems, and an object of the present invention is to provide, for example, a power generation device that performs efficient power generation even with weak input mechanical energy.

### Solution to Problem

In order to solve the above problems, the invention according to claim 1 includes: a permanent magnet having magnetic poles paired in a direction of a rotation axis; and a coil formed by winding a conducting wire around at least one radial axis directed outward from the rotation axis, in which a plurality of the permanent magnets are arranged at predetermined intervals, radially with respect to the rotation axis, and along a circumferential direction.

In addition, as for the invention according to claim 2, in the power generation device according to claim 1, the magnetic poles of the plurality of permanent magnets are the same magnetic pole on one side in the direction of the rotation axis.

In addition, as for the invention according to claim 3, in the power generation device according to claim 1 or 2, the permanent magnet is formed by inserting a plurality of permanent magnets into a magnet hole formed in the direction of the rotation axis with the same magnetic poles facing each other.

In addition, as for the invention according to claim 4, in the power generation device according to any one of claims 1 to 3, a tooth protrudes in a direction of the radial axis and a long side of a plate-shaped portion of the tooth extends in the direction of the rotation axis, and the coil is formed by winding the conducting wire around at least one of the teeth and extending in the direction of the rotation axis.

In addition, as for the invention according to claim 5, a power generation system includes a power generation device and a rotation control device controlling rotation of the power generation device, in which the power generation device includes a permanent magnet having magnetic poles paired in a direction of a rotation axis and a coil formed by winding a conducting wire around at least one radial axis directed outward from the rotation axis and a plurality of the permanent magnets are arranged at predetermined intervals, radially with respect to the rotation axis, and along a circumferential direction, and the rotation control device controls the rotation of the power generation device via the rotation axis.

### Advantageous Effects of Invention

According to the present invention, the power generation device includes the permanent magnet having the magnetic poles paired in the direction of the rotation axis and the coil formed by winding a conducting wire around the radial axis directed outward from the rotation axis, and the plurality of permanent magnets are arranged at predetermined intervals, radially with respect to the rotation axis, and along the circumferential direction. As a result, since the plurality of permanent magnets have the magnetic poles paired in the direction of the rotation axis, as compared with the case of disposing the permanent magnet that has magnetic poles paired in the direction of the radial axis directed outward from the rotation axis, rotation occurs smoothly even with weak input mechanical energy and efficient power generation is possible such that weak input mechanical energy can be converted into electrical energy.

### BRIEF DESCRIPTION OF DRAWINGS

FIG. 1A is a front view illustrating an overview configuration example of a power generation device according to an embodiment of the present invention.

FIG. 1B is a perspective view illustrating an overview configuration example of the power generation device according to the embodiment of the present invention.

FIG. 2 is a perspective view illustrating an example of a rotor of FIG. 1B.

FIG. 3A is a front view illustrating an example of the rotor of FIG. 1B.

FIG. 3B is a plan view illustrating an example of the rotor of FIG. 1B.

FIG. 3C is a cross-sectional view illustrating an example of the rotor of FIG. 1B.

FIG. 4A is a front view illustrating an example of a rotor component.

FIG. 4B is a plan view illustrating an example of the rotor component.

FIG. 4C is a cross-sectional view illustrating an example of the rotor components.

FIG. 5 is a schematic diagram illustrating an example of a permanent magnet.

FIG. 6 is a planar configuration diagram illustrating an example of a rotor equipped with the permanent magnet of FIG. 5.

FIG. 7 is a perspective view illustrating an example of magnetic pole directions of the permanent magnet in the rotor of FIG. 1B.

FIG. 8 is a front view illustrating an example of a stator component.

FIG. 9A is a schematic diagram illustrating an example of coils in a stator.

FIG. 9B is a schematic diagram illustrating a positional relationship between the permanent magnet and the coil.

FIG. 9C is a schematic diagram illustrating a positional relationship between the coil and radial axes.

FIG. 10 is a block diagram illustrating an overview configuration example of a power generation system.

FIG. 11 is a block diagram illustrating an example of a control device of FIG. 10.

FIG. 12 is a flowchart illustrating a power generation system operation example.

FIG. 13A is a perspective view illustrating a modification example of permanent magnet arrangement in the rotor.

FIG. 13B is a perspective view illustrating a modification example of the permanent magnet arrangement.

FIG. 14A is a perspective view illustrating a modification example of the permanent magnet arrangement in the rotor.

FIG. 14B is a perspective view illustrating a modification example of the permanent magnet arrangement in the rotor.

FIG. 14C is a perspective view illustrating a modification example of the permanent magnet arrangement in the rotor.

FIG. 15 is a perspective view illustrating a modification example of the permanent magnet arrangement in the rotor.

FIG. 16 is a perspective view illustrating a modification example of the permanent magnet arrangement in the rotor.

FIG. 17A is a front view illustrating a modification example of the power generation device according to the embodiment of the present invention.

FIG. 17B is a perspective view illustrating a modification example of the power generation device according to the embodiment of the present invention.

FIG. 18 is a schematic diagram illustrating an example of the coils in the stator.

FIG. 19 is a graph illustrating an example of the relationship between a rotation count and electric power.

### DESCRIPTION OF EMBODIMENTS

Hereinafter, an embodiment of the present invention will be described with reference to the drawings. Incidentally, the following embodiment pertains to a case where the present invention is applied to a power generation device.

### [1. Configuration and Function Overview of Power Generation Device, Etc.]

### (1.1 Configuration and Function of Power Generation Device)

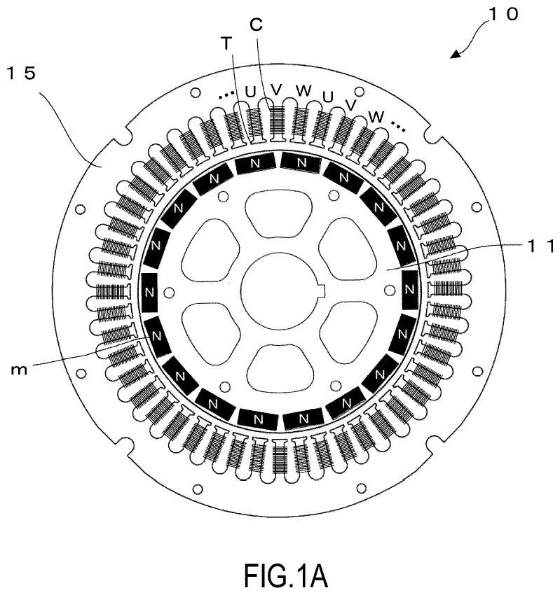

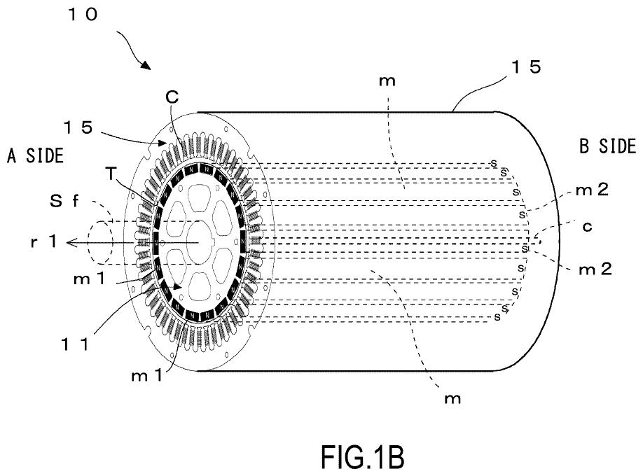

First, the configuration and overview function of a power generation device according to one embodiment of the present invention will be described with reference to FIGS. 1A and 1B.

As illustrated in FIGS. 1A and 1B, a power generation device 10 has a rotor 11 and a stator 15.

The rotor 11 is fixed to a shaft Sf and rotates together with the rotation of the shaft Sf. In the rotor 11, a plurality of permanent magnets m are arranged at predetermined intervals, radially with respect to the rotation axis of the shaft Sf, and along the circumferential direction.

As illustrated in FIG. 1B, the permanent magnet m has magnetic poles paired in the rotation axis direction of a rotation axis r1. For example, the A side in the direction of the rotation axis r1 of the power generation device 10, that is, an end surface m1 of the rod-shaped permanent magnet m is an N pole, and the B side in the direction of the rotation axis r1 of the power generation device 10, that is, an end surface m2 of the rod-shaped permanent magnet m is an S pole.

In addition, the magnetic poles of the plurality of permanent magnets m are the same magnetic pole on one side in the direction of the rotation axis r1. For example, the end surface m1 of every permanent magnet m on the A side in the direction of the rotation axis r1 of the power generation device 10 is an N pole, and the end surface m2 of every permanent magnet m on the B side in the direction of the rotation axis r1 of the power generation device 10 is an S pole.

The plurality of permanent magnets m are arranged at predetermined intervals, radially with respect to the rotation axis r1, and along the circumferential direction. For example, as illustrated in FIGS. 1A and 1B, eighteen rod-shaped permanent magnets m are arranged at predetermined intervals, radially with respect to the rotation axis r1, and along the circumferential direction, with the long axis direction of the permanent magnets m parallel to the rotation axis r1.

The stator 15 has a plurality of teeth T protruding in a T shape toward the rotation axis r1 of the shaft Sf and coils C wound around the teeth T.

The tooth T protrudes in the direction of a radial axis r2. A tip portion of the tooth T and the cylindrical surface of the rotor 11 have a predetermined gap.

As illustrated in FIGS. 1A and 1B, the coil C is formed by winding a conducting wire around at least one radial axis r2 directed outward from the rotation axis r1. The coils C are formed in the order of U-, V-, and W-phase coils in the rotational direction. The tooth T is formed to extend in the direction of the rotation axis r1 and, as illustrated in FIG. 1B, the coil C has a loop shape extending in the direction of the rotation axis r1.

The power generation device 10 generates three-phase AC power. Incidentally, the coil C may be formed such that the power generation device 10 generates a two-phase alternating current.

The permanent magnet m and the coil C are configured to be relatively rotatable with respect to the rotation axis of the shaft Sf.

### (1.2 Configuration and Function of Rotor)

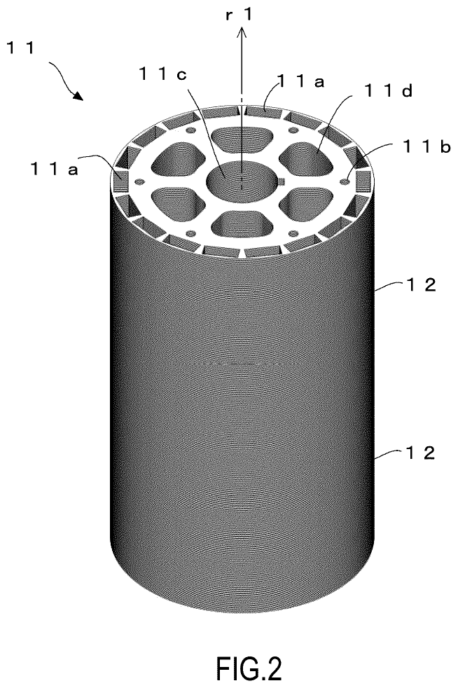

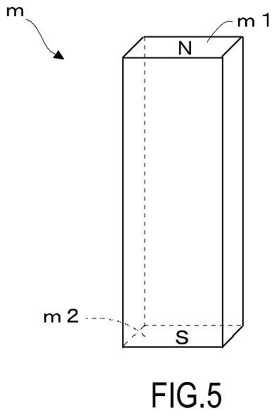

Next, the configuration and function of the rotor will be described with reference to FIGS. 2 to 7.

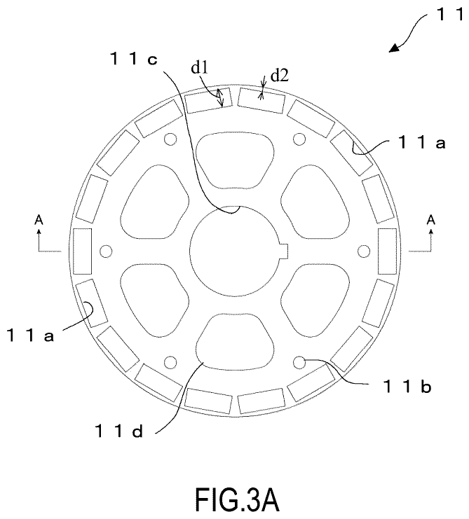

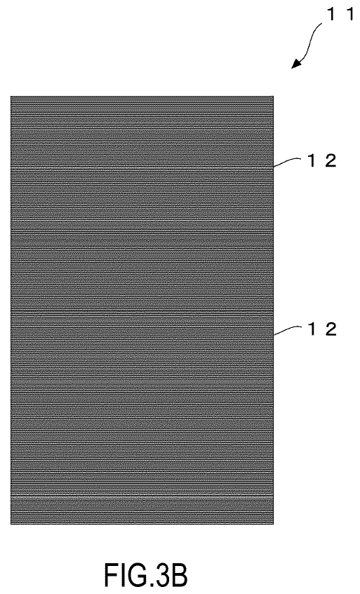

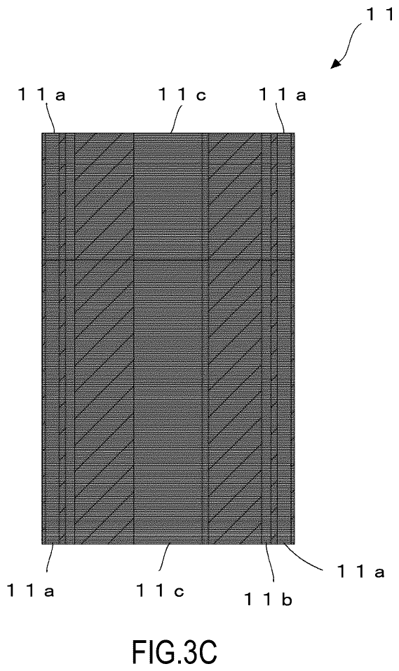

As illustrated in FIGS. 2 to 3C, the rotor 11 has magnet holes 11a into which the permanent magnets m are inserted, bolt holes 11b for interconnecting rotor plates 12, a shaft hole 11c through which the shaft Sf passes, and substantially fan-shaped holes 11d for weight reduction. The rotor 11 are formed in layers by stacking the rotor plates 12 in the direction of the rotation axis r1 of the shaft Sf.

The magnet holes 11a are formed near the outer peripheral surface of the rotor 11. As illustrated in FIG. 3A, a gap d2 between the outer peripheral surface of the rotor 11 and the magnet hole 11a is smaller than a thickness d1 of the permanent magnet m inserted into the magnet hole 11a.

A bolt is inserted into the bolt hole 11b to fix each stacked rotor plate 12.

The shaft Sf is inserted into the shaft hole 11c, and the rotor 11 and the shaft Sf are fixed.

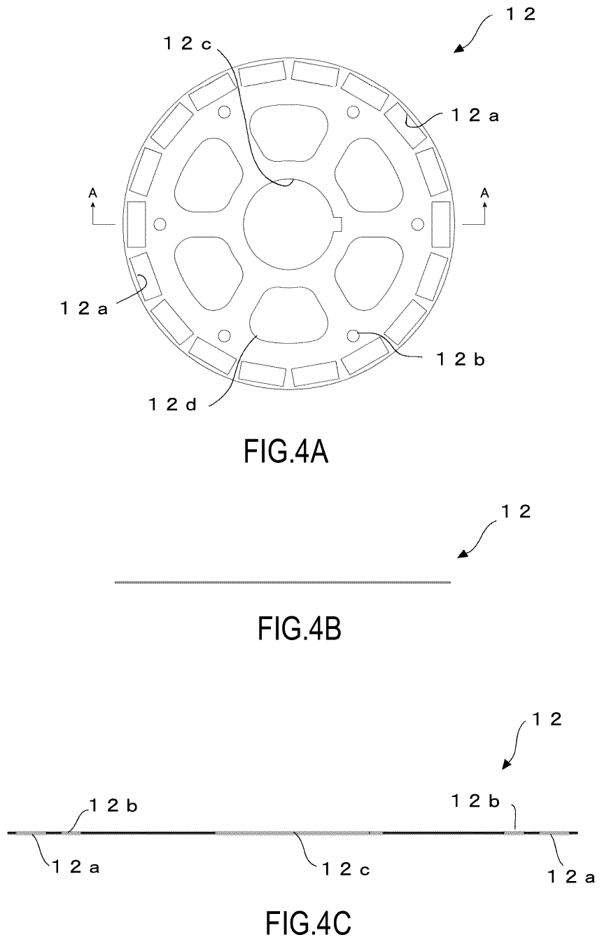

As illustrated in FIG. 4A, the circular rotor plate 12 configuring the rotor 11 has magnet holes 12a into which the permanent magnets m are inserted, bolt holes 12b for interconnecting the rotor plates 12, a shaft hole 12c through which the rotation axis of the shaft Sf passes, and fan-shaped holes 12d for weight reduction.

Incidentally, after the permanent magnet m is inserted into the magnet hole 11a, two lid members (not illustrated) for blocking the magnet hole 11a are applied from both sides in the direction of the rotation axis r1 of the rotor 11, and then a bolt is inserted to fix each stacked rotor plate 12. The lid member has the same size as the rotor plate 12 and has holes at the same positions as the bolt holes 11b and the shaft hole 11c.

The magnet holes 12a are formed in the rotor plate 12 at equal intervals, radially with respect to the rotation axis of the shaft Sf, and along the circumferential direction. For example, eighteen magnet holes 12a are formed near the outer periphery of the rotor plate 12. The shape of the magnet hole 12a is formed in accordance with the shape of the permanent magnet m.

The material of the rotor plate 12 is a metal such as soft iron, silicon steel, and aluminum. The material of the rotor plate 12 may be a magnesium alloy, an aluminum alloy, an alloy such as stainless steel, or reinforced plastic. Electromagnetic steel such as silicon steel is particularly preferable as the material of the rotor plate 12. The material of the lid member may be a metal such as soft iron, silicon steel, and aluminum and may be the same as the material of the rotor plate 12. The material of the rotor plate 12 may have a magnetic permeability equal to or greater than a predetermined value. Examples thereof include a material equal to or greater than carbon steel in magnetic permeability, a material equal to or greater than soft iron in magnetic permeability, and a material equal to or greater than silicon steel in magnetic permeability.

The rotor plate 12 is a thin core plate as illustrated in the plan view of FIG. 4B and the cross-sectional view of FIG. 4C. The thickness of the rotor plate 12 is, for example, 0.1 mm to 1 mm. As illustrated in FIG. 4B, the thickness of the rotor plate 12 is, for example, approximately 0.5 mm. Incidentally, the rotor 11 may be an iron core produced by metal lump shaving instead of a stacked core in which the rotor plates 12 are stacked. The thickness of the lid member and the thickness of the rotor plate 12 are, for example, 0.1 mm to 1 mm.

The stacked core of the rotor 11 is formed by stacking, for example, approximately 600 rotor plates 12 each with a thickness of 0.5 mm. The rotor plates 12 are stacked such that the respective holes of the rotor plates 12 are aligned, the magnet hole 11a of the rotor 11 is formed from the magnet hole 12a of the rotor plate 12, the bolt hole 11b of the rotor 11 is formed from the bolt hole 12b of the rotor plate 12, the shaft hole 11c of the rotor 11 is formed from the shaft hole 12c of the rotor plate 12, and the hole 11d of the rotor 11 is formed from the hole 12d of the rotor plate 12. A bolt is inserted into the bolt hole 11b, and the stacked rotor plates 12 are fixed such that the respective holes of the rotor plates 12 are aligned. The rod-shaped permanent magnet m can be inserted into the magnet hole 11a.

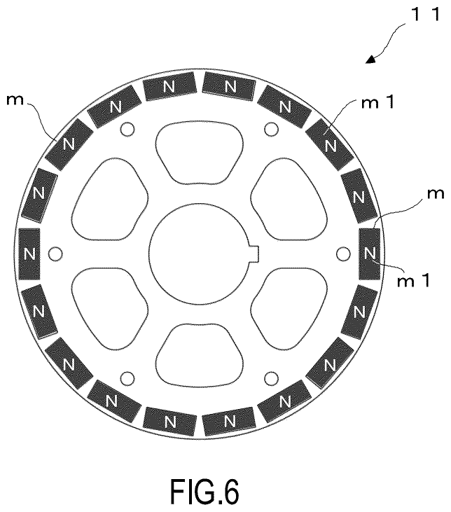

The permanent magnet m is, for example, a neodymium magnet, a samarium cobalt magnet, or the like. As illustrated in FIG. 6, the permanent magnet m has the shape of, for example, a quadrangular prism. The length of the rod-shaped permanent magnet m is, for example, the same as the length of the magnet hole 11a. The shapes and sizes of the end surfaces m1 and m2 of the permanent magnet m are suitable for the magnet hole 11a. The end surface m1 of the permanent magnet m forms an N pole, and the end surface m2 forms an S pole.

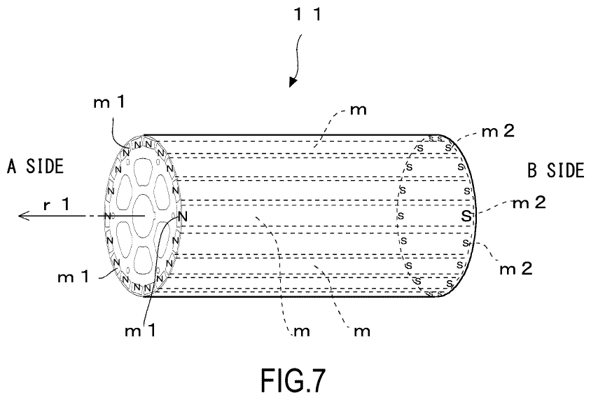

As illustrated in FIG. 7, the permanent magnet m is inserted into the magnet hole 11a such that the A side is an N pole and the B side is an S pole. The longitudinal direction of the permanent magnet m is set in the direction of the rotation axis r1 of the shaft Sf. Both ends of the rotor 11 formed by piling up and stacking the rotor plates 12 are covered with rotor plates blocking the opening portions of the magnet holes 11a into which the permanent magnets m are inserted, a bolt is passed through the bolt hole 11c for fixing, and the rotor 11 is formed as a result.

### (1.3 Configuration and Function of Stator)

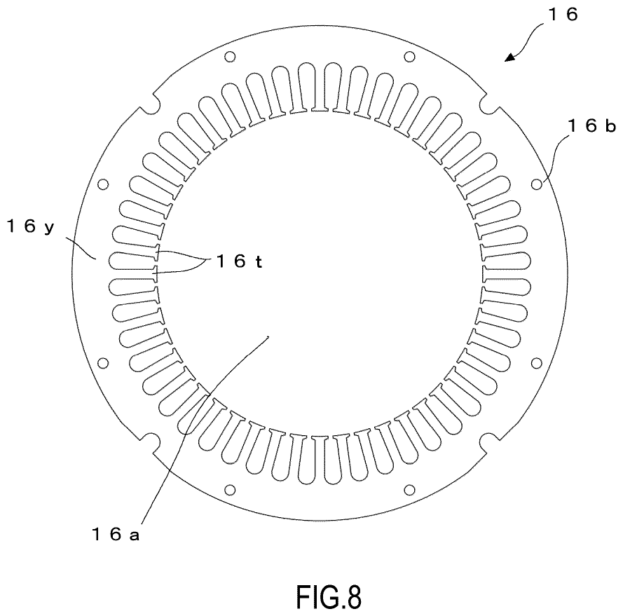

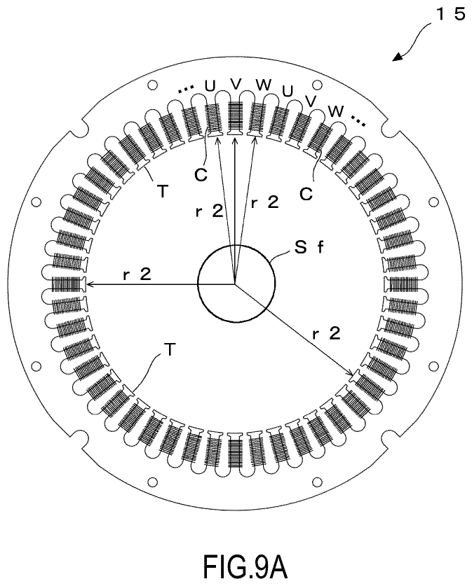

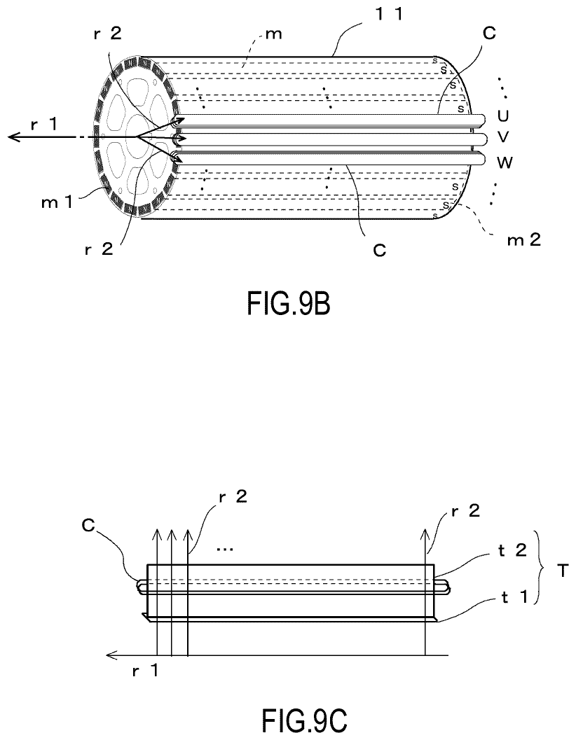

Next, the configuration and function of the stator will be described with reference to FIGS. 8 to 9.

As illustrated in FIG. 8, a circular stator plate 16 configuring the stator 15 has tooth portions 16t configuring the teeth T, an annular yoke portion 16y, a rotor hole 16a into which the rotor 11 is inserted, and bolt holes 16b for interconnecting the stator plates 16.

The tooth portion 16t radially protrudes from the yoke portion 16y. The tooth portions 16t are 48 in number. In number, the tooth portions 16t are a multiple of the number of three phases.

The inner diameter of the rotor hole 16a is larger than the outer diameter of the rotor 11 and forms a predetermined gap from the surface of the cylindrical rotor 11. For example, the gap is 0.3 [mm] to 2 [mm]. The thickness of the stator plate 16 is, for example, approximately 0.5 mm.

The material of the stator plate 16 is a metal such as soft iron, silicon steel, and aluminum. Electromagnetic steel such as silicon steel is particularly preferable as the material of the stator plate 16. The material of the stator plate 16 may be a material having a magnetic permeability equal to or greater than a predetermined value. Examples thereof include a material equal to or greater than carbon steel in magnetic permeability, a material equal to or greater than soft iron in magnetic permeability, and a material equal to or greater than silicon steel in magnetic permeability. The thickness of the stator plate 16 is, for example, 0.1 [mm] to 1 [mm].

The stacked core of the stator 15 is formed by stacking, for example, approximately 600 stator plates 16 each with a thickness of 0.5 mm. The stator plates 16 are stacked such that the respective holes of the stator plates 16 are aligned, the teeth T, which are the stator teeth of the stator 15, are formed by piling up the tooth portions 16t of the stator plates 16, the rotor hole of the stator 15 is formed from the rotor hole 16a of the stator plate 16, and the bolt hole of the stator 15 is formed from the bolt hole 16b of the stator 15. The length of the stator 15 in the direction of the rotation axis r1 is the same as the length of the rotor 11 in the direction of the rotation axis r1.

A bolt is inserted into the bolt hole of the stator 15, the stacked stator plates 16 are fixed such that the respective holes of the stator plates 16 are aligned, and the stator 15 is formed as a result. Incidentally, the stator 15 may be produced by metal lump shaving instead of stacking the stator plates 16.

As illustrated in FIGS. 9A and 9B, the V-phase teeth T, the U-phase teeth T, and the W-phase teeth T are formed in this order in the rotational direction. The copper wire coil C with a surface insulated with enamel or the like is wound around each tooth T by a predetermined number of turns. As illustrated in FIG. 9B, a conducting wire is wound around the tooth T by a predetermined number of turns with one radial axis r2 forming a row in the direction of the rotation axis r1, and the loop-shaped coil C extending in the direction of the rotation axis r1 is formed as a result. The V-phase coil C, the U-phase coil C, and the W-phase coil C are formed in this order in the rotational direction. The end point at which the conducting wire of the coil C turns back is outside the end point of the stator 15 in the direction of the rotation axis r1. The coils C of the respective phases are delta-connected or star-connected to output the respective phases.

As illustrated in FIG. 9C, the tooth T has a tip portion t1 with a T-shaped tip facing the cylindrical surface of the rotor 11 and a plate-shaped portion t2 connected to the yoke of the rotor 11. As illustrated in FIG. 9C, the coil C is wound around the plate-shaped portion t2 of the tooth T by a predetermined number of turns. The long side of the rectangular plate-shaped portion t2 of the tooth T extends in the direction of the rotation axis r1, and the short side of the rectangle extends in the direction of the radial axis r2 toward the rotation axis r1. The radial axes r2 radially extending from the rotation axis r1 are set so as to align the rotation axis. The coil C is wound by a predetermined number of turns with respect to the radial axes r2 arranged in a row.

Incidentally, the number of turns of the coil C may be variable in accordance with the tooth portion 16t count, that is, the distance between the tooth portions 16t that are adjacent to each other. The number of turns of the coil C is increased as the distance between the adjacent tooth portions 16t increases. As illustrated in FIGS. 9A and 9B, the coil C may be wound around the tooth T by distributed winding, such as concentric winding, lap winding, and wave winding, as well as concentrated winding. In addition, the rotor 11 may be fixed and the stator 15 may rotate.

[2. Configuration, Function Overview, and Operation of Power Generation System]

### (2.1 Configuration and Function Overview of Power Generation System)

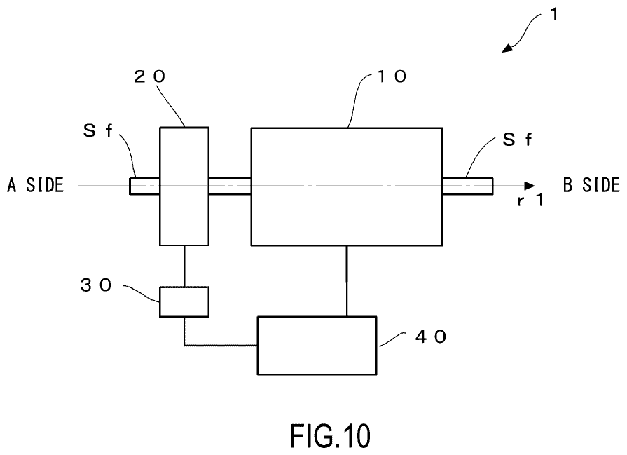

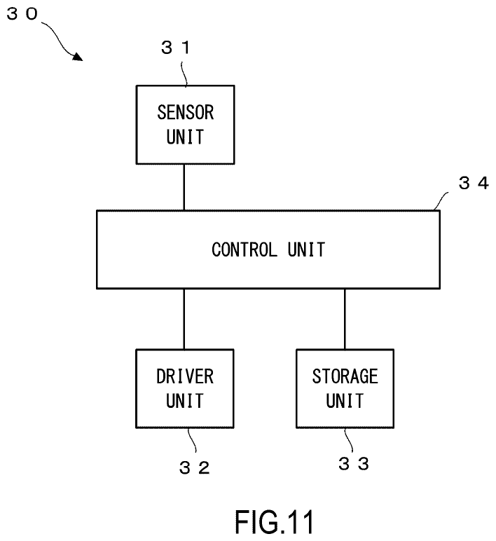

Next, a power generation system 1 using the power generation device 10 will be described with reference to FIGS. 10 to 11.

As illustrated in FIG. 10, the power generation system 1 includes the power generation device 10, a rotation control device 20 controlling the rotation of the power generation device 10, a control device 30 controlling the power generation system 1, and a power supply device 40 storing electricity generated by the power generation device 10. The power generation device 10 and the rotation control device 20 are connected in series by the rotating shaft of the shaft Sf. Incidentally, the input of mechanical energy of rotation may be the A side in the rotation axis of the shaft Sf or the B side where the rotation control device 20 is connected. In addition, a plurality of the power generation devices 10 may be connected in the direction of the rotation axis of the shaft Sf. The rotating shaft of the shaft Sf is rotatably supported by a bearing portion.

The rotation control device 20 has a motor rotating the rotating shaft of the shaft Sf. The rotation control device 20 is supplied with electric power from the power supply device 40 and controls the rotation of the power generation device 10 in conjunction with the power generation device 10 via the rotating shaft of the shaft Sf. For example, in a case of suppressing the rotation of the power generation device 10, the rotation control device 20 applies torque for reverse rotation of the rotation of the rotating shaft of the shaft Sf. In a case of accelerating the rotation of the power generation device 10, the rotation control device 20 applies torque for forward rotation of the rotation of the rotating shaft of the shaft Sf.

The motor of the rotation control device 20 may be a DC motor or an AC motor.

Incidentally, the rotation control device 20 may control the rotation of the power generation device 10 such that the rotation speed of the power generation device 10 can be maintained within a predetermined range. In a case where the input mechanical energy is weak and the rotation speed of the power generation device 10 has decreased, the rotation control device 20 applies torque to forward rotation. In a case where the input mechanical energy is strong and the rotation speed of the power generation device 10 has increased, the rotation control device 20 applies torque to reverse rotation.

Incidentally, the rotation control device 20 may supply generated regenerative energy to the power supply device 40 in a case where the rotation of the power generation device 10 is suppressed. The rotation control device 20 may be a braking device such as a mechanical brake in a case where the rotation of the power generation device 10 is suppressed.

As illustrated in FIG. 11, the control device 30 has a sensor unit 31, a driver unit 32 supplying electric power to drive the motor of the rotation control device 20, a storage unit 33, and a control unit 34 controlling each unit of the control device 30.

The sensor unit 31 has various sensors sensing the states of the power generation device 10, the rotation control device 20, and the power supply device 40. The sensor unit 31 senses the rotation speed, rotation count, electromotive force, current, and so on of the power generation device 10. In addition, the sensor unit 31 senses the regenerative energy of the rotation control device 20. For example, the rotational position of the rotor 11 is detected by a magnetic sensor such as a Hall element.

The driver unit 32 controls the amount of current flowing to the motor of the rotation control device 20, timings, rotational directions, and so on.

The storage unit 33 is configured by, for example, a hard disk drive, a silicon disk, or the like. In addition, the storage unit 33 may store various programs such as an operating system and a control program. Incidentally, the various programs may be acquired from, for example, another server via a network or may be recorded on a recording medium and read via a drive device.

The control unit 34 is, for example, a computer that has a central processing unit (CPU), a read only memory (ROM), and a random access memory (RAM). The control unit 34 controls the power generation system 1 in accordance with a program read from the storage unit 33. Incidentally, the control unit 34 may be configured by an electronic circuit of an element such as a transistor and an integrated circuit (IC).

The power supply device 40 has a battery unit storing electric power generated by the power generation device 10, an inverter for DC-to-AC conversion, and a converter for AC-to-DC conversion. The battery unit is a secondary battery such as a lead storage battery, a lithium-ion battery, a nickel-hydrogen battery, and a lithium-sulfur battery. The power supply device 40 may store the regenerative energy of the rotation control device 20.

In a case where the motor of the rotation control device 20 is a DC motor, electric power supply is received from the battery unit of the power supply device 40. In a case where the motor of the rotation control device 20 is an AC motor, electric power supply is received from the battery unit of the power supply device 40 via the inverter of the power supply device 40.

### (2.2 Operation of Power Generation System)

Next, the operation of the power generation system according to one embodiment of the present invention will be described with reference to the drawings.

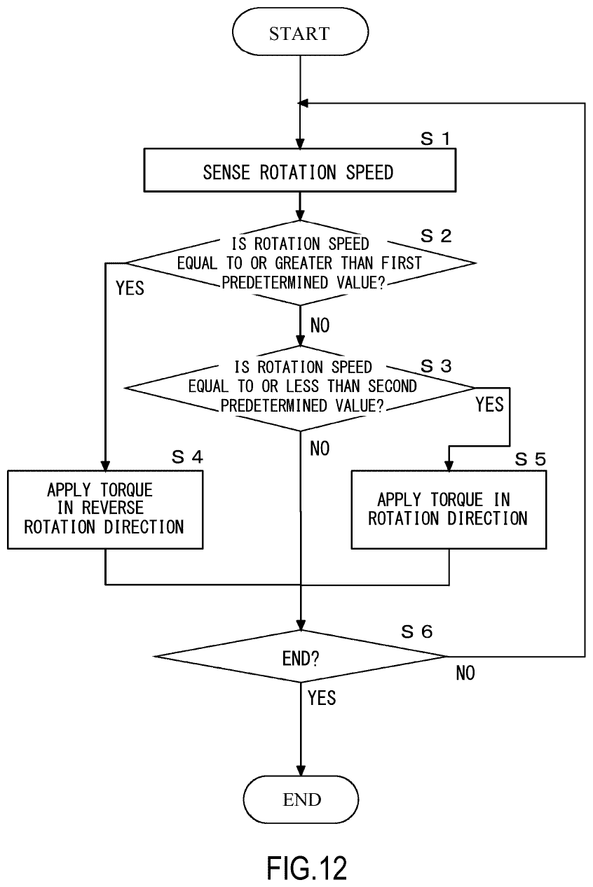

FIG. 12 is a flowchart illustrating an operation example of the power generation system 1.

First, the power generation system 1 receives the input of mechanical energy of rotation by wind power, hydraulic power, or the like. Incidentally, the rotor 11 of the power generation device 10 may be rotated by the motor of the rotation control device 20. At that time, the control device 30 controls the power supply device 40 to supply electric power from the power supply device 40 to the rotation control device 20.

When the rotor 11 rotating and the permanent magnet m of the rotor 11 approaching a specific coil C of the stator 15, the N pole of the end surface m1 of the permanent magnet m approaches one (A side) end point of the tooth T in the direction of the rotation axis r1 and the S pole of the end surface m2 of the permanent magnet m approaches the other (B side) end point of the tooth T in the direction of the rotation axis r1. Then, it is assumed that the magnetic flux from the N pole of the end surface m1 subsequently enters from the vicinity of the A side end point of the tooth T, the magnetic flux exits from the vicinity of the B side end point of the tooth T through the tooth T, and a magnetic circuit is formed as a result. It is assumed that a magnetic flux is generated in the direction of the rotation axis r1 in the coil C with a loop extending in the direction of the rotation axis r1.

It is assumed that when the rotor 11 rotating and the permanent magnet m of the rotor 11 moving away from the specific coil C of the stator 15, the magnetic flux passing through the tooth T decreases and the magnetic flux passing through the coil C also decreases.

Further, it is assumed that when the rotor 11 rotating and the next permanent magnet m in the rotor 11 approaching, the magnetic flux from the N pole of the end surface m1 enters from the vicinity of the A side end point of the tooth T, the magnetic flux exits from the vicinity of the B side end point of the tooth T through the tooth T, and a magnetic circuit is formed again as a result.

In this manner, the magnetic flux in the axial direction of the coil C, that is, the direction of the radial axis r2 of the coil C does not change much. Therefore, the cocking phenomenon is unlikely to occur. Incidentally, there is also the possibility that the magnetic flux passing through the coil C in the axial direction of the coil C has changed.

An induced electromotive force is generated in each V-phase coil, each U-phase coil, and each W-phase coil, and current is collected for each phase and output to the converter of power supply device 40. The power supply device 40 stores electric power in the battery unit. Incidentally, a three-phase alternating current may be output to the outside of the power generation system 1 or a direct current may be output from the converter of the power supply device 40.

As illustrated in FIG. 12, the power generation system 1 performs rotation speed sensing during power generation (step S1). Specifically, the sensor unit 31 senses information on the rotation speed of the rotor 11 of the power generation device 10. The control unit 34 of the control device 30 acquires the information on the rotation speed from the sensor unit 31. Incidentally, the sensor unit 31 may measure electromotive force, electric power, and so on.

Next, the power generation system 1 determines whether the rotation speed is equal to or greater than a first predetermined value (step S2). Specifically, the control unit 34 of the control device 30 determines whether the rotation speed is equal to or greater than the first predetermined value by comparing the rotation speed of the rotor 11 with the first predetermined value. Here, the first predetermined value is set to, for example, the mechanical limit rotation speed of the power generation device 10 or a rotation speed at which the efficiency of the power generation device 10 declines. In addition, the first predetermined value may be variable in accordance with the charging rate of the power supply device 40. For example, the control unit 34 decreases the first predetermined value when the charging rate of the battery unit of the power supply device 40 increases.

The control unit 34 of the control device 30 may detect, for example, the electric power generated in the coil C or the maximum electromotive force and determine whether the rotation speed is equal to or greater than the first predetermined value.

In a case where the rotation speed is not equal to or greater than the first predetermined value (step S2; NO), the power generation system 1 determines whether the rotation speed is equal to or less than a second predetermined value (step S3). Specifically, the control unit 34 of the control device 30 determines whether the rotation speed is equal to or less than the second predetermined value by comparing the rotation speed of the rotor 11 with the second predetermined value. Here, the second predetermined value is set to, for example, a rotation speed at which the cocking phenomenon is unlikely to occur or a rotation speed at which the efficiency of the power generation device 10 declines.

The control unit 34 of the control device 30 may detect, for example, the electric power generated in the coil C or the maximum electromotive force and determine whether the rotation speed is equal to or greater than the second predetermined value.

In a case where the rotation speed is equal to or greater than the first predetermined value (step S2; YES), the power generation system 1 applies torque in the reverse rotation direction (step S4). Specifically, the control unit 34 of the control device 30 controls the current supplied from the driver unit 32 to control the rotation control device 20 such that the motor of the rotation control device 20 applies torque in the reverse rotation direction to the rotating shaft of the shaft Sf. The driver unit 32 supplies current for the rotation control device 20 to generate torque in the reverse rotation direction. The rotation control device 20 applies the torque in the reverse rotation direction to the rotating shaft of the shaft Sf. Incidentally, in a case where the electric power generated in the coil C, the maximum electromotive force, or the like is equal to or greater than the first predetermined value, the rotation control device 20 may apply torque in the reverse rotation direction to the rotating shaft of the shaft Sf.

In a case where the rotation speed is equal to or less than the second predetermined value (step S3; YES), the power generation system 1 applies torque in the rotational direction (step S5). Specifically, the control unit 34 of the control device 30 controls the current supplied from the driver unit 32 to control the rotation control device 20 such that the motor of the rotation control device 20 applies torque in the rotational direction to the rotating shaft of the shaft Sf. The driver unit 32 supplies current for the rotation control device 20 to generate torque in the rotational direction. The rotation control device 20 applies the torque in the rotational direction to the rotating shaft of the shaft Sf. Incidentally, in a case where the electric power generated in the coil C, the maximum electromotive force, or the like is equal to or less than the second predetermined value, the rotation control device 20 may apply torque in the rotational direction to the rotating shaft of the shaft Sf.

Next, the power generation system 1 determines whether to end (step S6). Specifically, the control unit 34 of the control device 30 stops the control operation in a case where, for example, the power supply of the control device 30 or an end signal is received. In addition, the control device 30 may block the input of mechanical energy of rotation. The power generation system 1 may be stopped in a case where there is no input of mechanical energy of rotation for a predetermined time.

In the case of non-ending (step S6: NO), the power generation system 1 returns to the processing of step S1.

In a case where the wind weakens and the rotation speed decreases during wind power generation, the power generation system 1 applies torque in the rotational direction to the rotating shaft of the shaft Sf to maintain the rotation speed. In the event of an excessively strong wind, the power generation system 1 applies torque in the reverse rotation direction to the rotating shaft of the shaft Sf such that deceleration occurs and an excessive rotation speed is prevented. As a result, the power generation system 1 rotates and performs power generation with stability.

In the case of ending (step S6: YES), the operation of the power generation system 1 ends.

According to the present embodiment described above, the power generation device 10 includes the permanent magnet m having the magnetic poles paired in the direction of the rotation axis r1 and the coil C formed by winding a conducting wire around the radial axis r2 directed outward from the rotation axis r1 of the shaft Sf, and the plurality of permanent magnets m are arranged at predetermined intervals, radially with respect to the rotation axis r1, and along the circumferential direction. As a result, since the plurality of permanent magnets m have the magnetic poles paired in the direction of the rotation axis r1, as compared with the case of disposing the permanent magnet m that has magnetic poles paired in the direction of the radial axis r2 directed outward from the rotation axis r1, rotation occurs smoothly even with weak input mechanical energy and efficient power generation is possible such that weak input mechanical energy can be converted into electrical energy.

In a case where the magnetic poles of the plurality of permanent magnets m are the same magnetic pole on one side in the direction of the rotation axis r1, the change in magnetic field attributable to rotation becomes weak, rotation occurs smoothly even with weak input mechanical energy, and efficient power generation is possible such that weak input mechanical energy can be converted into electrical energy.

In a case where the permanent magnets m are formed by inserting the plurality of permanent magnets m into the magnet hole 11a formed in the direction of the rotation axis r1 with the same magnetic poles facing each other, the change in magnetic field attributable to rotation can be slightly enhanced.

In a case where the tooth T protrudes in the direction of the radial axis r2, the long side of the plate-shaped portion t2 of the tooth T extends in the direction of the rotation axis r1, and the coil C is formed by winding a conducting wire around at least one tooth T and extending in the direction of the rotation axis r1, a magnetic circuit of the magnetic flux in the coil C is formed with ease. Therefore, the rotation-attributable magnetic field can be changed greatly and, in particular, the coil C wound around the stator 15 can be caused to emit more current by increasing the magnetic field on the stator side.

In addition, heat dissipation and durability can be further improved in a case where the rotor 11 is formed in layers by the rotor plates 12. Heat dissipation is further improved especially in the case of a metal with high thermal conductivity or the like.

In addition, in a case where the stator 15 is formed in layers by the stator plate 16, heat dissipation and durability can be further improved.

In a case where the rotation speed of the rotating shaft of the shaft Sf is equal to or greater than the first predetermined value, the rotation control device 20 reduces the rotation speed of the rotating shaft of the shaft Sf via the rotating shaft. In a case where the rotation speed of the rotating shaft of the shaft Sf is equal to or less than the second predetermined value and the rotation control device 20 increases the rotation speed of the rotating shaft of the shaft Sf via the rotating shaft of the shaft Sf, the amount of electric power supply can be adjusted by performing acceleration or deceleration as described above within the limit rotation speed of the motor of the rotation control device 20.

In addition, the amount of power generation can be increased by having a plurality of the power generation devices 10 with respect to the rotation axis of the shaft Sf.

### Modification Examples

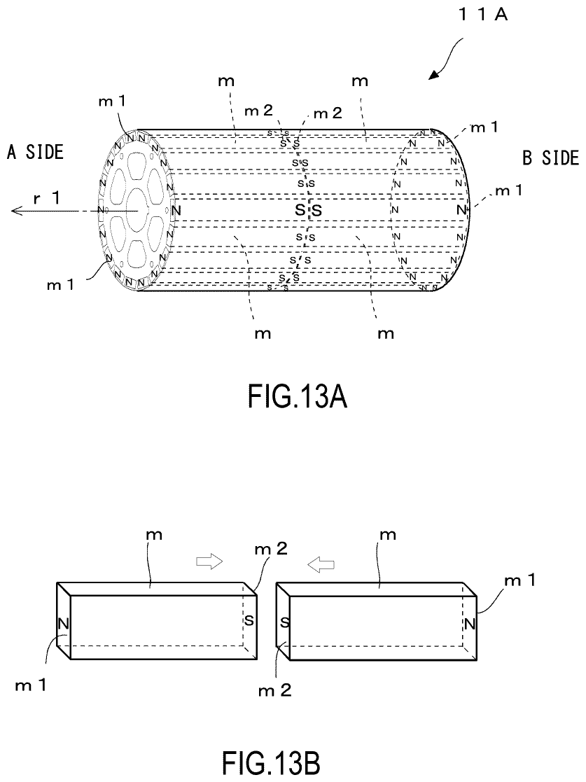

Next, modification examples of the rotor and the stator will be described with reference to FIGS. 13A to 18.

FIGS. 13A and 13B will also be used to describe a modification example of the permanent magnet arrangement in the rotor.

As illustrated in FIGS. 13A and 13B, the plurality of rod-shaped permanent magnets m may be inserted into the magnet hole 11a of a rotor 11A such that the same magnetic poles face each other. For example, the end surfaces m2 of two permanent magnets m face each other such that the S poles face each other, and the plurality of permanent magnets are inserted into one magnet hole 11a. Incidentally, two lid members for blocking the magnet hole 11a are not illustrated. In addition, the permanent magnet m may be disposed such that the N poles face each other and m2 of the S pole is on the outside.

The distance between the magnet hole 11a and the cylindrical surface of the rotor 11A is sufficiently short with respect to the size of the strong permanent magnet m, and thus it is assumed that magnetic flux leakage occurs from the vicinity of the surface of the cylindrical surface of the rotor 11A, where two permanent magnets m face each other. It is possible to cause a larger current to flow through the coil C wound around the stator 15 by increasing the magnetic flux to the outside of the rotor 11A, that is, the stator side.

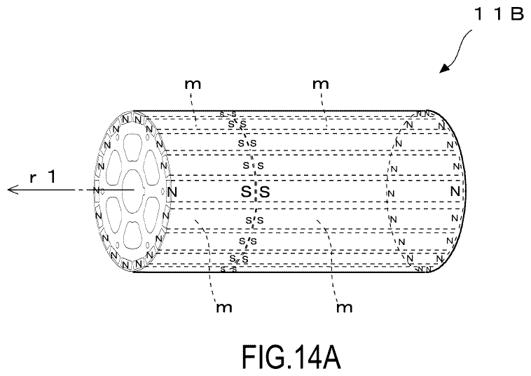

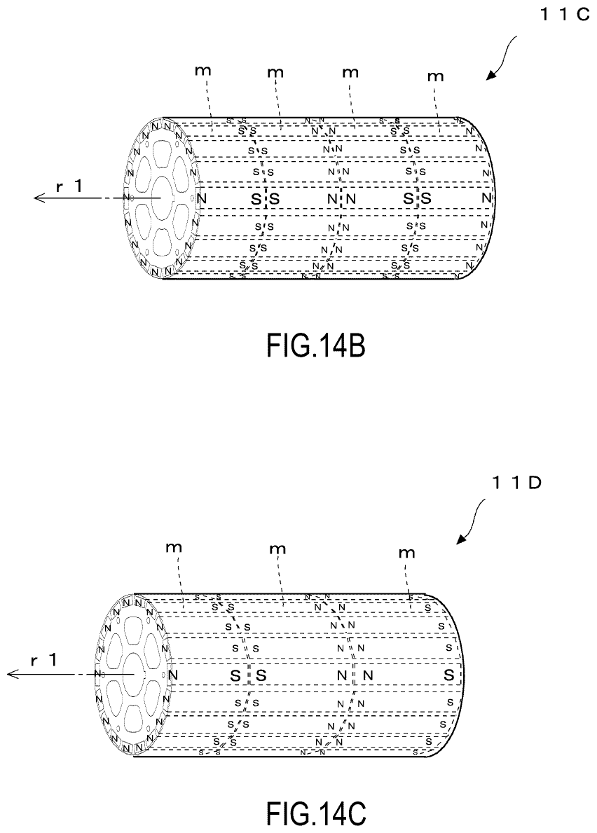

As illustrated in FIG. 14A, in the magnet holes 11a of a rotor 11B, the same magnetic poles may face each other and the plurality of permanent magnets m may have different lengths. Incidentally, the length of the permanent magnet in which the plurality of permanent magnets m are combined should be the length of the magnet hole 11a, and thus the combination of the lengths of the plurality of permanent magnets m may differ for each magnet hole 11a.

As illustrated in FIG. 14B, four permanent magnets m may be inserted into one magnet hole 11a such that the same magnetic poles face each other. Both sides of the rotor 11 in the direction of the rotation axis r1 are the same magnetic poles.

As illustrated in FIG. 14C, three permanent magnets m may be inserted into one magnet hole 11a of a rotor 11D such that the same magnetic poles face each other. In this case, both sides of the rotor 11D in the direction of the rotation axis r1 are different magnetic poles.

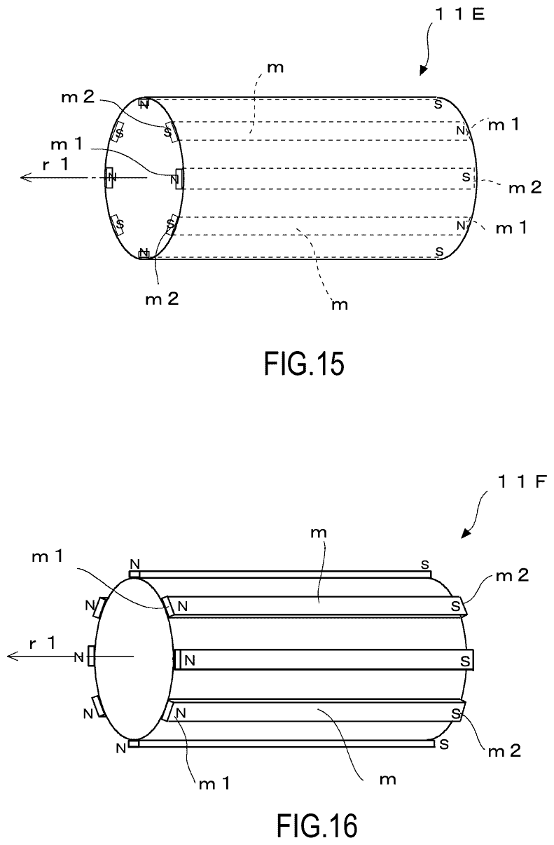

As illustrated in FIG. 15, the permanent magnets m may be arranged such that different magnetic poles are alternately arranged in order in the circumferential direction on both sides of a rotor 11E in the direction of the rotation axis r1. Incidentally, the permanent magnets m may be fitted into the rotor 11E from the outside.

As illustrated in FIG. 16, the permanent magnets in may be installed on the cylindrical surface of a rotor 11F such that both sides of the rotor 11E in the direction of the rotation axis r1 are the same magnetic poles.

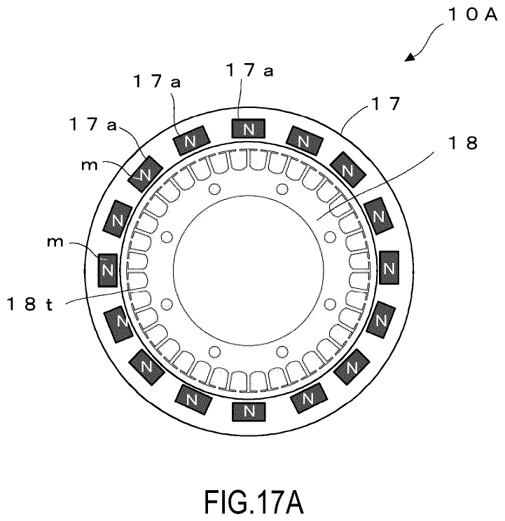

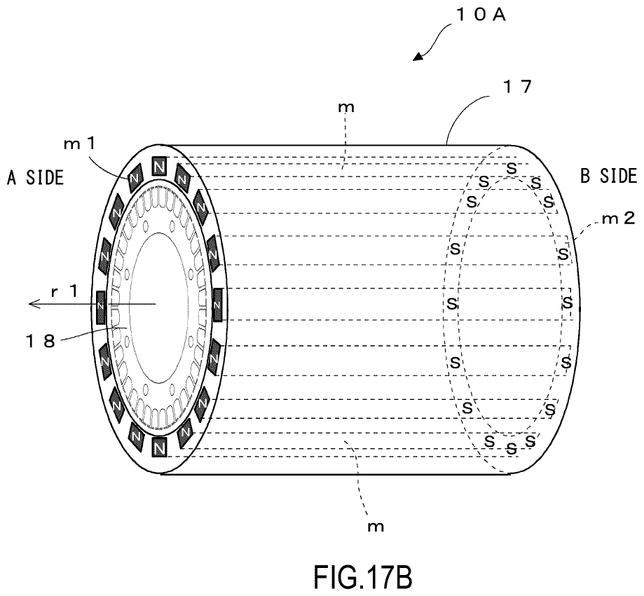

Next, a modification example of the power generation device will be described with reference to FIGS. 17A and 17B.

As illustrated in FIGS. 17A and 17B, in a power generation device 10A, an iron core 17 having the permanent magnets m may be on the outside and an iron core 18 having a coil may be on the inside. Incidentally, the iron core 17 may be a stator and the iron core 18 may be a rotor or the iron core 17 may be a rotor and the iron core 18 may be a stator.

The iron core 17 has magnet holes 17a. The magnet holes 17a are formed near the inner peripheral surface of the iron core 17. As illustrated in FIG. 17A, the gap between the inner peripheral surface of the iron core 17 and the magnet hole 17a is smaller than the thickness of the permanent magnet m inserted into the magnet hole 17a.

As illustrated in FIG. 17B, the permanent magnet m is inserted into the magnet hole 17a such that the A side is an N pole and the B side is an S pole. The longitudinal direction of the permanent magnet m is set in the direction of the rotation axis r1.

The iron core 18 is a stacked core, and the iron core 18 has a plurality of teeth 18t protruding in a T shape and radially from the rotation axis of the shaft and coils (not illustrated) wound around the teeth 18t. The coil has a loop shape extending in the direction of the rotation axis r1.

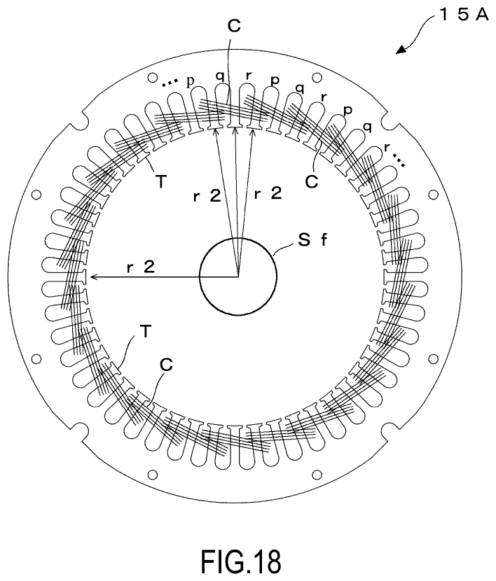

Next, a modification example of how to wind the coil C will be described with reference to FIG. 18.

As illustrated in FIG. 18, the method may be distributed winding in which the surface-insulated copper wire coil C is wound by a predetermined number of turns around three teeth T of a stator 15A.

In a case where concave portions p, q, and r are set in order, the U-phase coil C is wound so as to pass through the first concave portion p and the next second concave portion p. The coil C is not wound so as to pass through the second concave portion p and the next third concave portion p. The coil C is wound so as to pass through the third concave portion p and the next fourth concave portion p.

The V-phase coil C is wound so as to pass through the first concave portion r that is second-next to the first concave portion p and the next second concave portion r. The W-phase coil C is wound so as to pass through the first concave portion q that is second-next to the first concave portion r and the next second concave portion q.

### (Measurement Result)

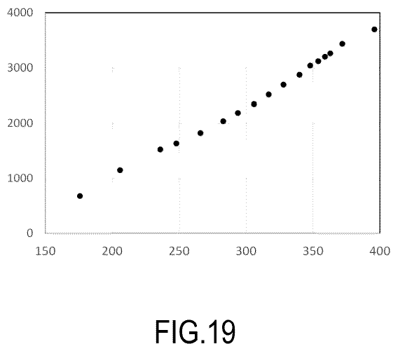

Next, an example of electric power measurement will be described with reference to FIG. 19. Incidentally, a reduction gear (not illustrated) was inserted between the motor of the rotation control device 20 and the power generation device 10 in order to achieve a stable low speed. In addition, the power generation device 10 used for the measurement is a combination of the rotor 11B and the stator 15A.

In FIG. 19, the horizontal axis is rotation count [rpm] and the vertical axis is effective power [w].

As illustrated in FIG. 19, the electric power output was substantially proportional to the rotation count and sufficient electric power was obtained even from low-speed rotation. In addition, the power generation device 10 rotated smoothly even at a low speed.

Incidentally, the present invention can be freely modified in design without departing from the spirit of the invention described in each embodiment of the present invention and is not limited to the contents described in each embodiment of the present invention.

### REFERENCE SIGNS LIST

10 Power generation device
11 Rotor
15 Stator
C Coil
m Permanent magnet
Sf Shaft
r1 Rotation axis
r2 Radial axis

1-5. (canceled)

6. A power generation device comprising:
permanent magnets each having magnetic poles paired in a direction of a rotation axis of a rotor having a cylindrical surface; and
a coil formed by winding a conducting wire around at least one radial axis directed outward from the rotation axis, wherein
in the rotor, the permanent magnets are inserted into respective magnet holes formed in the direction of the rotation axis at predetermined intervals, radially with respect to the rotation axis, and along a circumferential direction,
a tooth protrudes in a direction of the radial axis and a long side of a plate-shaped portion of the tooth extends in the direction of the rotation axis, and
the coil is formed by winding the conducting wire around at least one of the teeth and extending in the direction of the rotation axis.

7. The power generation device according to claim 6, wherein
the magnetic poles of the plurality of permanent magnets are the same magnetic pole on one side in the direction of the rotation axis.

8. The power generation device according to claim 6, wherein
the permanent magnet is formed by inserting a plurality of permanent magnets into one magnet hole with the same magnetic poles facing each other.

9. A power generation system comprising a power generation device and a rotation control device controlling rotation of the power generation device, wherein
the power generation device
includes permanent magnets each having magnetic poles paired in a direction of a rotation axis of a rotor having a cylindrical surface and a coil formed by winding a conducting wire around at least one radial axis directed outward from the rotation axis,
in the rotor, the permanent magnets are inserted into respective magnet holes formed in the direction of the rotation axis at predetermined intervals, radially with respect to the rotation axis, and along a circumferential direction, a tooth protrudes in a direction of the radial axis, a long side of a plate-shaped portion of the tooth extends in the direction of the rotation axis, and the coil is formed by winding the conducting wire around at least one of the teeth and extending in the direction of the rotation axis, and
the rotation control device controls the rotation of the power generation device via the rotation axis.
